(19) United States
(12) Patent Application Publication
(10) Pub. No.: US 2015/0296833 A1
(43) Pub. Date: Oct. 22, 2015

(54) NATURAL TEXTURE MODIFIER DELIVERING BODY AND SWEETNESS TO FROZEN CONFECTION PRODUCTS

(71) Applicant: NESTEC S.A., Vevey (CH)

(72) Inventors: Madhavi Ummadi, Bakersfield, CA (US); Nishant Ashok Joshi, Sioux City, IA (US)

(21) Appl. No.: 14/649,300

(22) PCT Filed: Dec. 6, 2013
(86) PCT No.: PCT/EP2013/075783

§ 371 Date: Jun. 3, 2015

Related U.S. Application Data
(60) Provisional application No. 61/734,462, filed on Dec. 7, 2012.

(51) Int. Cl. A23G 9/34

(52) U.S. Cl. CPC A23G 9/34; A23V 2002/00

(57) ABSTRACT

The present invention relates to a frozen confection product comprising oat syrup, a natural sweetening agent. Preferably the frozen confection product is prepared by using a standard freezing step followed by low temperature extrusion and by acidifying the ingredient mix for preparing the frozen confection product. Furthermore, the invention relates to a method of preparing the frozen confection product.

### TECHNICAL FIELD

The present invention relates to frozen confection products. More particularly the present invention relates to frozen confection products comprising natural sweeteners. More particularly the present invention relates to frozen confection products comprising oat syrup.

Furthermore, the invention relates to a method of preparing the frozen confection product.

### BACKGROUND OF THE INVENTION

Many different kinds of sweeteners are used in the frozen confection industry, such as sucrose, invert sugar, molasses, brown sugar, refiners' syrup and corn syrups. Corn syrup solids have been used to substitute sucrose solids in frozen confection formulations for many years. The typical ratio of sucrose:corn syrup is 70:30 or 60:40 to achieve the desired sweetener solids concentration of 15-25% in the finished product.

In addition to sweetness, the types of sweeteners used in frozen confection also affect the freezing point, viscosity, smoothness, body, and melting qualities of the frozen confection. In order to generate a natural and consumer preferred product, the frozen confection needs to have a firm body and a texture with desirable melting properties. This has been achieved by using sucrose:corn syrup ratios of 60:40 in low fat ice cream formulations. In contrast, formulations using sucrose alone do not deliver enough body and texture to the final product without the use of hydrocolloids as stabilizers.

Consumers are increasingly concerned about purchasing and consuming products that the consumers view as being healthier and containing only natural ingredients. The type of corn syrup currently used is not considered natural, since the commercially available corn syrups are chemically hydrolyzed by acid treatment.

In addition, consumers demand products which are truly “All Natural” and the corn syrup traditionally used in the ice cream industry is considered non-natural.

Furthermore, there is an existing demand from consumers of frozen confections to buy frozen confections prepared from full fat, low fat or non-fat formulations, while maintaining their good sensorial properties or even improve the sensory attributes.

Hence, there is an unmet need for frozen confection products, which contain natural sweeteners that is naturally hydrolyzed with natural enzymes. Also, there is an unmet need for frozen confection products, which are preferably free from stabilizers, artificial and non-natural emulsifiers, and other ingredients such as eggs and acacia gum, and which have improved sensorial properties.

### SUMMARY OF THE INVENTION

An object of the present invention relates to providing frozen confection products which contain oat syrup as a natural sweetener.

The first aspect of the invention relates to a frozen confection product comprising oat syrup.

In a preferred embodiment of the invention, the frozen confection product is preferably devoid of stabilizers, artificial (non-natural) emulsifiers and allergens.

In particular, it is an object of the present invention to provide frozen confection products which contain oat syrup as a natural sweetener. It is another object of the present invention to provide frozen confection products which are preferably devoid of artificial (non-natural) emulsifiers, stabilizers and allergens, using minimal number of base ingredients and at the same time have a very light, creamy, and smooth texture. It is another object of the present invention to provide frozen confection products comprising oat syrup preferably with an overrun between 20-150%. Furthermore, it is an object of the present invention to obtain a frozen dessert with a good body and texture and with a stable foam structure without the stability of the frozen confection being compromised.

In addition, it is an object of the present invention to obtain a frozen confection products with improved heat shock resistance, when comparing it to products comprising corn syrup.

The inventors of the present invention have surprisingly found that by using a syrup type that comes from natural enzyme hydrolysis of oats can be used as a natural corn syrup substitute and can not only deliver the sweetness, but also delivers the desired body and texture properties in frozen confection products.

Over the recent years, consumers of frozen confections are becoming more and more demanding and conscious about what they eat and tend to prefer products with fewer additives or totally avoid additives. Thus, consumers are more and more seeking products that contain a minimum of ingredients on their label, i.e. have a clean label.

Therefore, the consumers' demand of products with a clean label, i.e. contain natural sweetener, and preferably free of additives such as artificial emulsifiers, stabilizers and allergens, is met.

Another aspect of the present invention is the use of a pH adjusting agent, such as organic acids, preferably glucono-delta-lactone for manufacturing a frozen confection product.

Another aspect of the present invention relates to a method of producing a frozen confection product comprising oat syrup, comprising the steps of:

a) providing an ingredient mix comprising at least dairy components, emulsifier and sweetening agent, and if needed stabilizers;
b) homogenizing the mix;

c) pasteurizing the mix;

d) freezing the pasteurized mix to form the frozen confection product;
e) optionally hardening the mix.

In general, the various aspects of the invention may be combined and coupled in any way possible within the scope of the invention. These and other aspects, features and/or advantages of the invention will be apparent from and elucidated with reference to the embodiments described hereinafter.

The present invention will now be described in more detail in the following.

### BRIEF DESCRIPTION OF THE FIGURES

FIG. 1 a-d. shows a microscopic picture of a four different ice cream samples.

FIG. 2 shows the particle size curves for the four different ice cream samples.

FIG. 3 shows the melt test results for the four different ice cream samples.

### DETAILED DESCRIPTION

### Definitions

Prior to discussing the present invention in further details, the following terms and conventions will first be defined:

In the context of the present invention, mentioned percentages are weight/weight percentages unless otherwise stated.

The term “and/or” used in the context of the “X and/or Y” should be interpreted as “X”, or “Y”, or “X and Y”.

Numerical ranges as used herein are intended to include every number and subset of numbers contained within that range, whether specifically disclosed or not. Further, these numerical ranges should be construed as providing support for a claim directed to any number or subset of numbers in that range. For example, a disclosure of from 1 to 10 should be construed as supporting a range of from 1 to 8, from 3 to 7, from 4 to 9, from 3.6 to 4.6, from 3.5 to 9.9, and so forth. All references to singular characteristics or limitations of the present invention shall include the corresponding plural characteristic or limitation, and vice versa, unless otherwise specified or clearly implied to the contrary by the context in which the reference is made.

Unless defined otherwise, all technical and scientific terms used herein have the same meaning as commonly understood by one of ordinary skill in the art (e.g. in frozen confection manufacture). Definitions and descriptions of various terms and techniques used in frozen confection manufacture are found in ice Cream, 6^{th} Edition, Robert T Marshall, H. Douglas Goff and Richard W Hartel (2003), Kluwer Academic/Plenum Publishers.

As used in this specification, the words “comprises”, “comprising”, and similar words, are not to be interpreted in an exclusive or exhaustive sense. In other words, they are intended to mean “including, but not limited to.

The term “essentially consist” means that at least 95% of the ingredients have to be natural, such as at least 97%, preferably at least 98%, even more preferably at least 99%.

The term “natural ingredients” refer in the context of the present invention to ingredients of natural origin. These include ingredients which come directly from the field, animals, etc. or which are the result of a physical or microbiological/enzymatic transformation process. These therefore do not include ingredients which are the result of a chemical modification process.

Essentially free” means in the context of the present application, that these material are not intentionally added for their conventional property imparting abilities, e.g. stabilizing, although there could be unintended minor amounts present without detracting from the performance of the products. Generally and preferably, the products of the invention will not contain any non-natural materials.

By the term “essentially or completely free” is therefore meant that the product comprise 2% by weight or less of a given compound, such as 1% by weight or less of a given compound.

The embodiments of the present invention described below are not intended to be exhaustive or to limit the invention to the precise forms disclosed in the following detailed description. Rather the embodiments are chosen and described so that others skilled in the art may appreciate and understand the principles and practices of the present invention.

The first aspect of the invention relates to a frozen confection product comprising oat syrup.

### Frozen Confection Product:

In the context of the present invention the term “frozen confection product” means a confection product comprising ice crystals distributed throughout a sweetened and/or flavored aqueous product and typically having a refreshing and cooling effect with a nice appearance.

Frozen confections include water in the form of ice crystals and are for consumption in a frozen or semi-frozen state, i.e. under conditions wherein the temperature of the product is less than 0° C., and preferably under conditions wherein the product comprises a significant amount of ice crystals.

Frozen confections may also be called “frozen confections”, “frozen confection products”, “ice desserts” or “frozen desserts” and these terms may be used interchangeably.

In an embodiment of the invention the frozen confection product is an aerated frozen confection product, in particular a frozen dairy dessert.

By the term “frozen aerated confection product” is meant any aerated frozen dessert.

In the context of the present invention, the term “aerated” refers to a product which has air cells distributed evenly throughout the product. The air cells or air bubbles can be distributed throughout the product for example by extrusion or whipping air into the product, e.g. whipping of air into an ice cream mix. For example one volume part of air whipped into one volume part of ice cream mix is equal to 100% overrun, as described by Marshall, Goff and Hartel.

In an embodiment of the present invention, the product has an overrun of at least 20%, such as in the range of 20-150%, preferably in the range of 80-130%, even more preferably in the range of 100-130%.

Overrun relates to the amount of air whipped in to an ingredient mix for preparing aerated products. Overrun is a term generally recognized for the skilled person within the field of ice cream production. In the present invention overrun is defined as the increase in volume, in percentage, of ice cream greater than the volume of the mix used to produce that ice cream due to incorporation of air. In other words, if you start off with 1 litre of mix and you make 2.0 litres of ice cream from that, you have increased the volume by 100% (i.e., the overrun is 100%).

In an embodiment of the invention, the frozen confection may be selected from the group of frozen dairy dessert, cultured frozen dairy dessert, ice cream, non-fat ice cream, low-fat ice cream, frozen yoghurt, milk shake, milk ice, and sherbet.

In a preferred embodiment, the frozen confection product is an ice cream, which may be a full fat ice cream, low fat ice cream and non-fat ice cream.

In an embodiment of the invention, the frozen confection product comprises from 0.5% to 16% fat by weight.

In another embodiment of the present invention, the confection product is a low fat product and comprises at most 6% fat.

In the context of the present invention, the term “fat” should be interpreted broadly and generally relates to one or more triglycerides independent of their melting temperature. The term “fat” comprises both triglycerides that are in liquid form at 25° C., as well as triglycerides that are in solid or semi-solid form at 25° C. Fatty acid triesters of the trihydroxy alcohol glycerol which are present in plant and animal tissues that can occur both as liquid or semi-liquid or solid fat forms. The physical and chemical properties of fats and oils depend on the nature of the fatty acids present. Saturated fatty acids give higher-melting fats and represent solid fats, for example, lard and butter. Unsaturation lowers the melting point of fatty acids and fats, e.g. plant oils, contain large amounts of unsaturated fatty acids.

According to a preferred embodiment of the invention, the product essentially consists of natural ingredients.

### Sweetening Agents

The product of the invention may comprise one or more sweetening agents. Sweetening agent refers to an ingredient or mixture of ingredients which imparts sweetness to the final product. These include preferably natural sugars such as cane sugar, beet sugar, molasses, other plant-derived nutritive sweeteners, and non-nutritive high intensity natural sweeteners.

In addition to sweetness, the types of sweeteners used in ice cream also affect the freezing point, viscosity, smoothness, body, and melting qualities.

The inventors of the present invention have surprisingly discovered a syrup type that comes from natural enzyme hydrolysis of oats. This oat syrup can replace the currently used corn syrup, which is not considered natural as it is acid hydrolyzed. This oat syrup is consumer friendly and natural. The optimization of the usage levels of the oat syrup led to a full bodied frozen confection product with highly desirable texture and slower melt rate. This natural and clean label oat syrup delivered not only the sweetness, but also the desired body and texture properties in product.

The first aspect of the invention relates to a frozen confection product comprising oat syrup as a sweetening agent.

In another embodiment of the invention, the frozen confection product comprises sweetening agent in an amount of from 15 to 25% by weight, wherein the amount of oat syrup is 3 to 6% by weight.

In a further embodiment of the invention, the product is preferably free of polysaccharides. Polysaccharides are mainly hydrocolloids, and they are disliked by many consumers. In ice cream polysaccharides, mainly hydrocolloids, are used to modulate the texture. The consumers prefer textural attributes in ice creams, such as ice cream having a smooth, creamy texture will be perceived as the right mouthfeel. When polysaccharides are overused in ice cream production, they can contribute to a gummy, sticky or chewy texture that consumers dislike.

### Protein:

The confection product according to the present invention comprises one or more proteins. The protein(s) may be selected from any dairy protein and plant protein.

In a preferred embodiment of the present invention, the protein is a dairy protein. The protein may also be a plant protein such as soya protein, pea protein, wheat protein, corn protein, and rice protein, proteins from legumes, cereals and grains in general. The protein may also be protein isolates from nuts or seeds.

In another embodiment of the present invention, the protein includes a partially coagulated protein system including kappa-casein and beta-lactoglobulin.

The term “partially coagulated protein system” is to be understood to mean a complex or an aggregate resulting from at least a partial coagulation of proteins present in the ingredient mix, for instance induced by the presence of an acidifying agent combined with a heat treatment.

Most milk proteins (mainly caseins) in their native state remain in colloidal suspension form leading to minimal changes in mix viscosity (˜200-400 cp). However, when proteins are subjected to controlled exposure to known amounts of heat and acid (e.g., pH of 6.1 or less and pasteurization) they undergo coagulation to form protein aggregates. During this controlled coagulation the proteins are hydrated, resulting in a three dimensional network (soft gel) causing increased mix viscosity (˜199-2400 cp). If the exposure of proteins to heat and acid is not controlled, this phenomenon could lead to precipitation (e.g. syneresis in yoghurt).

The inventors of the present invention have surprisingly found that when adding an emulsifier preferably a natural emulsifier to an ice cream mix including a partially coagulated protein system, for example addition of an acidifying agent to an ice cream mix comprising dairy proteins, a product with improved sensorial properties is obtained as compared to products only comprising an acidifying agent and no emulsifiers and as compared to products with an emulsifier preferably an natural emulsifier but no acidifying agent added. Without being bound by any theory, it is believed that this is due to the fact that the protein aggregation is synergistically increased in products comprising an emulsifier preferably an natural emulsifier and an acidifying agent as compared to products only comprising either an emulsifier preferably an natural emulsifier or an acidifying agent.

Without being bound by any theory, it is believed that partial coagulation of proteins within the ice cream mix is providing freshly coagulated proteins that act as a natural stabilizer for the air cells and enable creation of a very fine and stable microstructure resulting in a smooth, rich and creamy product without the use of artificial or non-natural emulsifiers or stabilizers or similar additives. This makes the products more natural and desirable for consumers who wish to minimize their intake of such artificial or non-natural additives.

In particular, the synergistic effect of the freshly coagulated proteins obtained by addition of an emulsifier preferably an natural emulsifier, and preferably in combination with a pH adjusting agent (acidifying agent), in combination with low temperature freezing technology is therefore leading to superior products in terms of texture and stability.

Preferably, the proteins are dairy proteins which are usually present in an ice cream mix and which comprises casein and whey proteins. Such proteins may undergo partial coagulation.

### pH Adjusting Agent:

According to a particular embodiment of the invention, the pH is controlled by the presence of a pH adjusting agent. The pH adjusting agent may for example be molasses, an edible organic acid such as citric acid, acetic acid, lactic acid, malic acid, ascorbic acid, benzoic acid, fumeric acid, lactones such as glucono-delta-lactone, fruit derived acids and fermentation derived acids.

In a preferred embodiment of the invention, the product comprises a pH adjusting agent. The pH adjusting agent is in the context of the present invention an acidifying agent.

The pH adjusting agent will as described earlier result in coagulation or aggregation of the proteins present in the ingredient mix for preparing the frozen confection product.

The pH adjusting agent is added in an amount such as to obtain a pH in the products in the range of 5.0 to 6.5, preferably in the range of 5.1 to 6.3, such as in the range of 5.3 to 6.0, even more preferably in the range of 5.4 to 5.9, such as in the range of 5.5 to 5.8.

When the protein system is partially coagulated prior to addition to the other components, the pH can be as high as 6.4 without detracting from the organoleptic properties of the product.

When using an emulsifier, preferably a natural emulsifier in combination with a pH adjusting agent such as organic acids, preferably glucono-delta-lactone, an increased aggregation of protein will be obtained as compared to products only comprising either an emulsifier preferably a natural emulsifier or a pH adjusting agent. By protein aggregation the large milk proteins structure in an ice cream mix is broken into smaller proteins, i.e. the proteins are un-folded. These unfolded proteins have the ability to increase the water holding capacity and form a unique 3-D network, i.e. trap water and small fat particles inside them. This results in increasing mix viscosity and making an ice cream mix, which is thick and viscous when extruded through the low temperature freezer (LTF), and which helps the ice cream product to attain a unique smooth and creamy texture that mimics the presence of higher fat levels.

Further, the use of artificial emulsifiers, stabilizers, and other ingredients such as acacia gum and egg yolk can be fully avoided, while maintaining a stable creamy foamed product.

Thus, in a preferred embodiment of the invention, the product is preferably essentially or completely free of any artificial or non-natural emulsifier, stabilizers, and other ingredients such as acacia gum and eggs such as egg yolk or egg white.

In another embodiment of the invention, the frozen confection product comprises a pH adjusting agent in an amount of 0.05 to 2.0% by weight, preferably in an amount of 0.06 to 1.0%, such as 0.07 to 0.8%, even more preferably in an amount of 0.1 to 0.3% by weight.

In a preferred embodiment of the present invention, the pH adjusting agent is a mild organic acid to get the desired protein aggregation.

In the context of the present invention, the term “mild acid” refers to acids which have slow and mild acidification capabilities. A “mild acid” is a weak acid and hereby is to be understood an acid which partially dissociate ions as compared to strong acids, e.g. hydrochloric acid, which has a complete dissociation of ions. For example acetic acid has a pKa of 4.74 and gluconic acid has a pKa of 3.70.

When using an emulsifier preferably a natural emulsifier as an emulsifying agent in frozen confection products in combination with a pH adjusting agent, a product is preferably essentially or completely free of artificial emulsifiers, stabilizers, and other ingredients such acacia gum and egg can be prepared which at the same time has an improved texture and mouthfeel. Further, the product has an improved flavor release as it is free of other emulsifiers, gums, stabilizers which inhibit flavor release. This new composition for preparation of frozen desserts can be manufactured on a conventional primary freezer and still give a smooth and creamy texture, even when prepared with an overrun above 100%. However, when using a low temperature extrusion and/or low temperature freezing, a product with an even better texture can be prepared having a rich and creamy texture.

Further, the reduction of fat in frozen confections without compromising the indulgent quality of the product is one of the main challenges faced by the ice cream industry. The present invention is overcoming this issue by providing low fat or even non-fat products with similar texture and sensory attributes as those having higher fat contents in terms of creaminess and flavor delivery.

### Emulsifiers/Stabilizers:

In an embodiment of the invention, the product comprises at least one emulsifier. In a preferred embodiment of the invention, the product comprises at least one natural emulsifier

According to a preferred embodiment of the invention, the product essentially consists of natural ingredients.

Examples of artificial and non-natural ingredients which are preferably avoided in a particular embodiment of the invention include for example the following emulsifiers; mono- and diglyceride of fatty acids, acid esters of mono- and diglycerides of fatty acids such as acetic, lactic, citric, tartaric, mono- and diacetyl tartaric acid esters of mono- and diglycerides of fatty acids, mixed acetic and tartaric acid esters of mono- and diglycerides of fatty acid, sucrose esters of fatty acids, polyglycerol esters if fatty acids, polyglycerol polyricinoleate, polyethylene sorbitan mono-oleate, polysorbate 80 and, chemically extracted lecithins.

The term “artificial emulsifiers” may also be referred to as synthetic emulsifiers or non-natural emulsifiers and the terms may be used interchangeably.

Chemically modified starches which are used in the art as stabilizers are also preferably avoided. These include for example modified starch, monostarch phosphate, distarch phosphate, phosphate or acetylated distarch phosphate, acetylated starch, acetylated distarch afipate, hydroxyl propyl starch, hydroxypropyl distarch phosphate, acetylated modified starch.

The products of the present invention are preferably essentially free of the preceding synthetic esters and modified starches.

In another preferred embodiment of the present invention, the product is preferably essentially or completely free of egg, such as free of egg yolk. Egg yolk, buttermilk and raw acacia gum, are natural emulsifiers known in the art to be used in emulsifying frozen desserts. These natural emulsifiers have the advantage of conferring to the finished product a smoother texture and stiffer body which improve the whipping efficiency. The presence of natural emulsifiers results in air cells that are smaller and more evenly distributed throughout the internal structure of the ice cream. However, some natural emulsifiers have a negative perception by the consumer, such as acacia gum. Egg yolk as natural emulsifier has the problem of containing allergens which will be distributed throughout the product. Thus, these kind of natural emulsifiers are undesirable for consumers. In the present invention, emulsifiers, preferably natural emulsifiers are used to emulsify the product, which has shown to provide a smooth creamy texture and possible to be used in products with a high overrun, such as between 80-150% and by conventional primary freezers.

### Additional Ingredients:

According to a particular embodiment of the present invention, the product comprises of fat in an amount of 0-20% by weight, preferably 0-13%, milk-solid non-fat in an amount of 5-15% by weight, preferably 10-13%, a sweetening agent in an amount of 5-30%. Preferably, the product comprises 0.5 to 5.5% fat which is representative of a low-fat or non-fat product.

Milk-solid-non-fat (MSNF) includes protein, carbohydrates and ash (minerals) in a dairy product. The protein content in MSNF is normally about 45%.

The product may additionally comprise flavorings, colorings, inclusions, sauces, water or any mixtures thereof. Such flavorings or colorings, when used, are preferably selected from natural ingredients. These are used in conventional amounts which can be optimized by routine testing for any particular product formulation.

### Method:

An aspect of the present invention related to the method of producing a frozen confection product comprising oat syrup, comprising the steps of:

a) providing an ingredient mix comprising at least dairy components, emulsifier and sweetening agent, and if needed stabilizers;
b) homogenizing the mix;
c) pasteurizing the mix;
d) freezing the pasteurized mix and
e) optionally hardening the mix.

The inventors of the present invention has surprisingly found out the method will give the consumers the desired ice cream body and textural experience of frozen dairy systems even at full fat, low fat or non-fat contents.

The applicant has found that optimization of the usage level of the oat syrup as a sweetening agent in preparing a frozen confection product would lead to a more full bodied frozen confection product with desired mouth feel and a slower melt rate, which is preferred by consumers. The frozen confection product is kosher and meets all the requirements of the food safety standards.

In a preferred embodiment of the invention the method relates to producing a frozen aerated confection product.

Continuous pasteurization is performed under standard conditions and may be carried out prior to or after homogenization. Preferred pasteurization conditions include heating to a temperature between 75° C. to 90° C., such as between 80° C. to 90° C., even more preferably between 83° C. to 87° C. for a period of 30 to 120 seconds, preferably from 30 to 90 seconds.

Batch pasteurization is preferably performed by heating to a temperature between 69° C. to 85° C., such as between 70° C. to 80° C. for a period of 30 to 120 minutes.

Homogenization can be done either prior to or after pasteurization. It is preferably carried out under standard conditions, namely at a pressure of between 40 and 200 bars, preferably between 100 and 150 bars, more preferably between 120 and 140 bars.

The homogenized mix may then be cooled to around 2 to 8° C. by known means. The mix may further be aged for 4 to 72 hours at around 2 to 6° C. with or without stirring. Optionally, the addition of flavorings, colorings, sauces, inclusions etc. may be carried out prior to the ageing step.

In the next step, the mix is frozen. In an embodiment of the invention the freezing is made while aerating the pasteurized mix. In a preferred embodiment, the mix may be cooled to a temperature below −3° C., preferably between −3 and −10° C., even more preferably between at about −4.5 to −8° C. with stirring and injection of a gas to create a desired overrun.

The aerating may be performed to an overrun from 20 to 150%, preferably from 50 to 140%, such as from 80-130%, and even more preferably from 100 to 130%.

In a preferred embodiment of the invention, the method comprises a step of adjusting the pH of the mix before pasteurization, in particular adjusting the pH of the mix with an acidifying agent to a pH in the range of 5.0 to 6.5.

In another preferred embodiment of the invention, the method comprises a step of adjusting the pH of the mix after pasteurization, in particular adjusting the pH of the mix with an acidifying agent to a pH in the range of 5.0 to 6.5, preferably 5.0 to 5.6.

The aerated mix is then subjected to freezing either by using standard continues freezing equipment or by using a low temperature extrusion system. In this equipment, the aerated mix is cooled by extrusion at a temperature of below −11° C., preferably between −12° C. and −18° C. in a screw extruder. The screw extruder may be as described in WO 2005/070225. The extrusion may be performed in a single or multi screw extruder.

The freezing in step d) is made by using a standard continuous industry freezer, such as a Taylor freezer or WCB (Waukesha Cherry Burrell Ice Cream Freezer).

In a preferred embodiment of the invention, the primary freezing step in step d) is followed by a step of low temperature freezing. The low temperature freezing, may also be termed low temperature extrusion, is reducing the product temperature from −10° C. to −18° C.

A further object is to provide a low temperature extruded frozen confection product comprising oat syrup as a sweetening agent, an emulsifier, preferably a natural emulsifier and a pH adjusting agent.

Low-temperature extrusion is a known process which imparts to the final product a specific and advantageous microstructure. For instance, ice crystal size and air bubble size tend to be smaller than in traditional manufacturing processes. On the other hand, the size of fat globules does not change significantly when LTE process is used.

With an emulsifier, preferably a natural emulsifier as the only emulsifier, it is possible to produce a frozen confection being stable and having a high overrun even when extruded through a low temperature freezer or a conventional freezer.

In a preferred embodiment of the invention, the freezing is made first through a primary conventional freezer and then through a secondary low temperature freezer to achieve a creamy frozen dessert.

Products known, which are made by low temperature freezing are described in US 2007/0196553, the content of which is here-included by reference. For instance, ice crystal size and air bubble size tend to be smaller than in traditional manufacturing processes. Ice crystals, air cells, fat globules and agglomerates thereof shall be in a specific diameter range in order to enhance positive sensory and stability characteristics.

The low-temperature extruded frozen confection products of the present invention have a smoother mouth feel and have particularly appealing textural and organoleptic properties, compared to low temperature extruded products known to date. Besides the frozen confection product of the present invention is preferably free of stabilizers, non-natural emulsifiers, and other ingredients such as egg yolk, acacia gum and non-natural sweetening agents.

The frozen mix is then packaged and stored at temperatures colder than −20° C., where it will undergo hardening step during storage. Alternatively, it can be hardened by accelerated hardening step, for example via a hardening tunnel, carried out at a temperature between −20° C. to −40° C. for a sufficient time to harden the product.

The method of the invention lends itself to the manufacture of frozen confections which are shelf-life stable at the necessary storage temperatures and have superior organoleptic and textural properties.

It has surprisingly been found out by the inventors of the present invention that a low temperature extruded product comprising an emulsifier, preferably a natural emulsifier, a pH adjusting agent and oat syrup as a sweetening agent, has a substantially improved the sensory profile. In particular, the product has an improved smooth and creamy texture.

It should be noted that embodiments and features described in the context of one of the aspects of the present invention also apply to the other aspects of the invention.

All patent and non-patent references cited in the present application, are hereby incorporated by reference in their entirety.

The invention will now be described in further details in the following non-limiting examples.

### EXAMPLES

### Example 1

### Clean Label (NSW) all Natural Ice Cream

An all natural frozen confection was prepared by using WCB (Waukesha Cherry Burrell Ice Cream Freezer) only (non-LTF) as well as WCB and LTF freezer. The all natural frozen confection had only 6 ingredients including oat syrup and whey protein phospholipid concentrate (clean label) and an overrun of 100-130%.

TABLE 1
Recipe used

| Ingredients | Wt % in final product |
|---|---|
| Fat | 5-6% |
| Sugar | 11-15% |
| Oat Syrup | 3-6% |
| MSNF | 10-13% |
| Natural emulsifier | <3% |
| Total solids | 36-41% |

The six all natural ingredients used were: milk, cream, sweetening agent such as sugar and oat syrup, vanilla and whey protein phospholipid concentrate.

Glucono Delta Lactone (GDL) was used to reduce pH of the base mix before pasteurization. This lower pH combined with heat treatment results in controlled coagulation in the mix, which delivers superior textural attributes to the final product.

Oat Syrup (Natu-Oat 62, supplier: Meurens Natural S.A.) gave excellent body and texture to the product and significantly improved the overall mouth feel and perception of the product.

The pH of the mix was reduced to 5.8-6.0 before pasteurization by addition of GDL. It was standardized to 5-6% fat and 10-12% MSNF, and then processed at below given parameters.
All Natural 5 ingredients system
Pasteurized at 180 F for 90 sec.
Homogenization at 1500 psi (Stage I), 500 psi (Stage II)
LTF inlet and outlet pressure were very stable.
LTF and non-LTF samples were collected.
Overrun for LTF sample was 125% and non-LTF (primary freezer) was 100%.

The end product had a very smooth and creamy texture coming out of the LTF freezer at 125% overrun.

### Example 2

### A Comparative Study of Products with and without Oat Syrup and Two Market Samples without Oat Syrup

TABLE 2
Recipe of a clean label ice cream without oat syrup (Sample No. 2587)

| Ingredients | % in final product |
|---|---|
| Milk Fat | 5.5 |
| MSNF | 11-13 |
| Sweetening agent | 18-22 |
| Natural Emulsifier | 1-3 |

TABLE 3
Recipe of a clean label ice cream with oat syrup (sample No. 2614)

| Ingredients | % in final product |
|---|---|
| Milk Fat | 5.5 |
| MSNF | 11-13 |
| Sweetening agent | 15-18 |
| Natural Emulsifier | 1-3 |
| Oat Syrup | 3-6 |

TABLE 4
Recipe of market sample 1—SlowChurned Vanilla

| Ingredients | % in final product |
|---|---|
| Milk Fat | 5.5 |
| MSNF | 11-13 |
| Sweetening agent | 18-22 |
| Stabilizer & Emulsifier | 0.5-2 |

TABLE 5
Recipe of market sample 2—Grand Vanilla

| Ingredients | % in final product |
|---|---|
| Milk Fat | 10.5 |
| MSNF | 11-13 |
| Sweetening agent | 18-22 |
| Stabilizer & Emulsifier | 0.5-2.0 |

### Drip Test (Melt Test) Method:

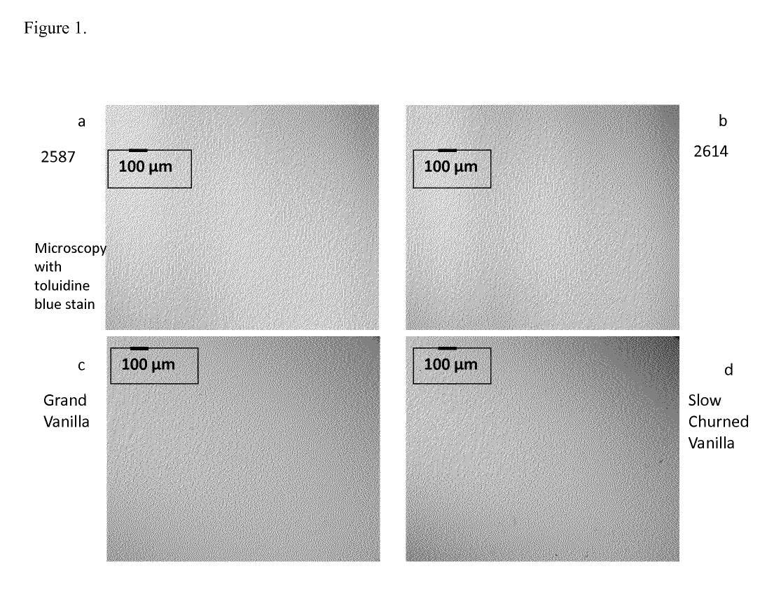

Ice cream samples of uniform cylindrical shape, approximately 180 mL in volume, were placed on wire mesh trays in a temperature controlled chamber at 22° C. Each mesh tray was suspended from a weighing balance, recording the remaining weight at 10 second intervals over a period of 3 hours. Photographs of each sample (FIG. 1) were taken at 10 minute intervals to track changes in shape.

### Microscopy Method:

A 0.2 gram sample of frozen dairy dessert was added to 1.8 grams of a stain solution consisting of 0.04% Toluidine Blue O in water. The sample was stirred to melt and disperse. After 60 seconds of equilibration, a drop of the mixture was placed onto a glass microscope slide and viewed at an effective magnification of approximately 100×.

In this study, products with and without oat syrup and two market samples without oat syrup of recipes of Tables 2-5 are compared. Microscopic pictures of the products have been made, which are shown in FIG. 1. FIG. 1 a. shows a microscopic picture of a clean label ice cream without oat syrup prepared by standard continuous freezing, i.e. not low temperature freezing. FIG. 1 b. shows a microscopic picture of a clean label ice cream with oat syrup prepared by the same method as FIG. 1 a. FIG. 1 c. shows a microscopic picture of market sample 2, Grand Vanilla. FIG. 1 d. shows a microscopic picture of market sample 1, Slow Churned Vanilla. The pictures show the particle size of the products. The size range of these particles lies in the range from 0.5 to 20 μm, which shows that the particle size distribution of the different products is comparable.

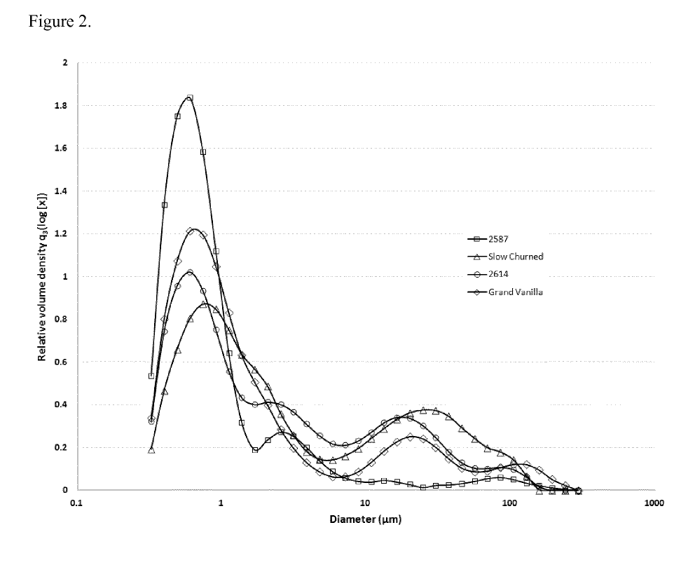

FIG. 2 shows the particle size curves for the four different ice cream samples. The diagram also clearly shows that the particle size distribution of the different products is comparable.

### Example 3

### A Comparative Study of Products with and without Oat Syrup and Two Market Samples without Oat Syrup

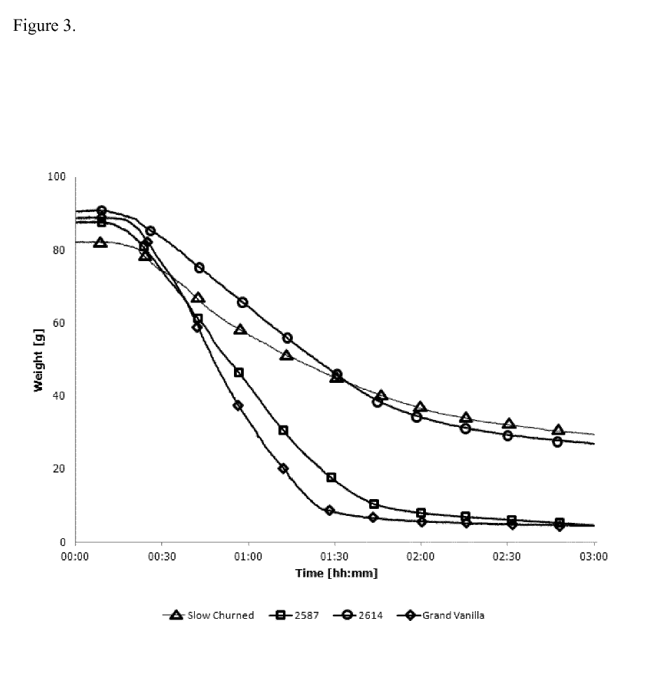

FIG. 3 shows the melt test results for the four different ice cream samples of Example 3. The X-axis shows the time (in hours and minutes) duration while the samples were subjected to melt test at 22 degree Celsius. The Y-axis shows the weight (in grams) of ice cream samples for all 4 samples of Example 3.

Market sample 1 and the sample of the clean label ice cream with oat syrup are very comparable in melt profile and characteristics, which shows better stability of the final product in the presence of oat syrup. The data clearly show that the addition of oat syrup definitely helps to maintain the melt profile to be the same as the melt profile of the products containing artificial corn syrup. Therefore, oat syrup is a good “natural” substitute to use. Also without the addition of the corn syrup the final product tends to melt faster which means that the ice cream has no body.

1. A frozen confection product comprising oat syrup.

2. The product according to claim 1, wherein the amount of oat syrup is 3-6% by weight.

3. The product according to claim 1, wherein the product is completely free of corn syrup.

4. The product according to claim 1, wherein the product comprises a pH adjusting agent in an amount of 0.05 to 2.0% by weight.

5. The product according to claim 4, wherein the pH adjusting agent is an organic acid.

6. The product according to claim 1, wherein the product comprises at least one emulsifier in an amount of 0.1 to 10.0% by weight.

7. The product according to claim 1, wherein the product comprises at least one component selected from the group consisting of dairy components, sweetening agent, emulsifier and flavor.

8. The product according to claim 7, wherein the dairy component is selected from the group consisting of milk, cream and mixtures thereof.

9. The product according to claim 1, wherein the product is all natural.

10. The product according to claim 1, wherein the product is completely free of polysaccharides.

11. The product according to claim 1, wherein the product is obtainable by a step selected from the group consisting of conventional freezing, by low-temperature extrusions and low temperature freezing.

12. The product according to claim 1, wherein the product has an overrun between 20 to 150% by volume.

13. The product according to claim 1, wherein the product is completely free of any artificial or non-natural emulsifiers or stabilizers.

14. A method of producing a frozen aerated confection product comprising oat syrup, comprising the steps of:
providing an ingredient mix comprising at least dairy components, emulsifier and sweetening agent;
homogenizing the mix;
pasteurizing the mix; and
freezing the pasteurized mix to form the aerated frozen confection product.

15. The method according to claim 14, wherein the freezing is achieved by using a standard continuous freezer followed by a low temperature freezing step.

16. The method according to claim 14, wherein the method comprises adjusting the pH of the mix before pasteurization with the pH adjusting agent to the range of 5.0 to 6.5.

17. The method according to claim 14, wherein the method comprises adjusting the pH of the mix after pasteurization.

18. The method of claim 14 comprising hardening the mix.
